(19) United States
(12) Patent Application Publication
(10) Pub. No.: US 2022/0167591 A1
(43) Pub. Date: Jun. 2, 2022

(54) Canine Harness Pack Assembly

(71) Applicant: Anthony Sullivan, II, Cataula, GA (US)

(72) Inventor: Anthony Sullivan, II, Cataula, GA (US)

(21) Appl. No.: 17/108,048

(22) Filed: Dec. 1, 2020

(51) Int. Cl. A01K 27/00; A01K 7/00

(52) U.S. Cl. CPC A01K 27/002; A01K 7/00; A01K 27/008

(57) ABSTRACT

A canine harness pack assembly for enabling a canine to transport items includes a harness and a pack. The harness is attachable to a canine so that the harness is positioned around a chest of the canine. The pack is selectively engageable to a top of the harness so that the pack is substantially centered on a back of the canine. An item can be positioned in the pack therein so that the canine is positioned to transport the item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to harness pack assemblies and more particularly pertains to a new harness pack assembly for enabling a canine to transport items. The present invention comprises a harness and pack combination wherein the pack is reversibly couplable to the harness by means of a set of snap connectors.

### (2) Description of Related Art Including Information Disclosed Under 37 CFR 1.97 and 1.98

The prior art relates to harness pack assembly. The prior art comprises harness and pack combinations and vest and pack combinations, which are attachable to dogs so that the dogs can carry items stowed within the pack elements. What is lacking in the prior art is a harness and pack combination wherein the pack is reversibly couplable to the harness by means of a set of snap connectors.

### BRIEF SUMMARY OF THE INVENTION

An embodiment of the disclosure meets the needs presented above by generally comprising a harness and a pack. The harness is configured to be attachable to a canine so that the harness is positioned around a chest of the canine. The pack is selectively engageable to a top of the harness so that the pack is substantially centered on a back of the canine. The pack is configured to have an item positioned therein so that the canine is positioned to transport the item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a canine harness pack assembly according to an embodiment of the disclosure.

FIG. 2 is a detail view of an embodiment of the disclosure.

FIG. 3 is a top view of an embodiment of the disclosure.

FIG. 4 is a kit view of an embodiment of the disclosure.

FIG. 5 is an in-use view of an embodiment of the disclosure.

### DETAILED DESCRIPTION OF THE INVENTION

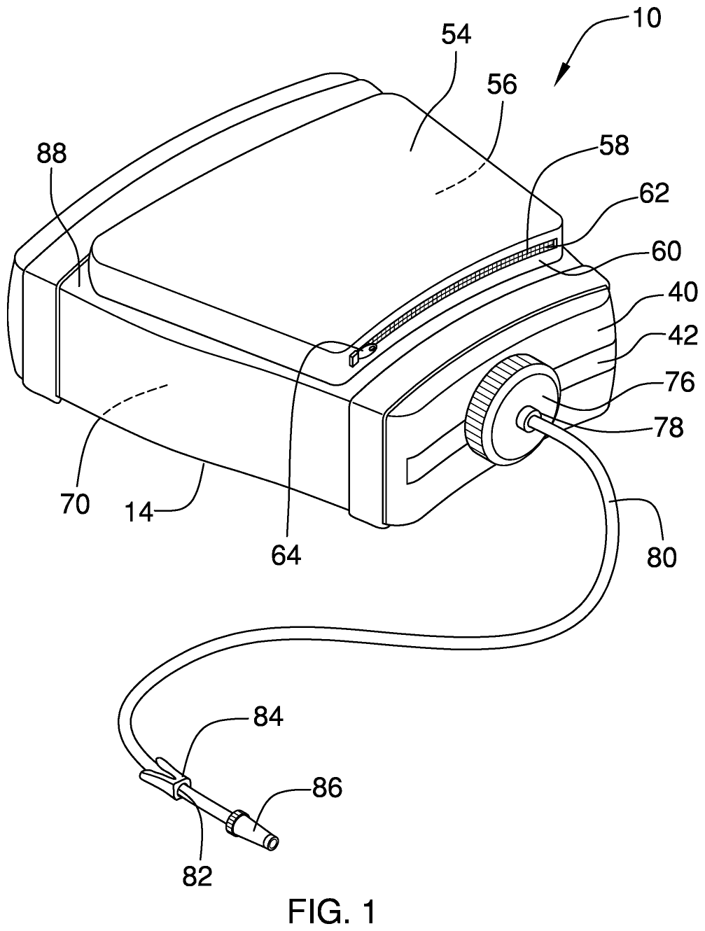

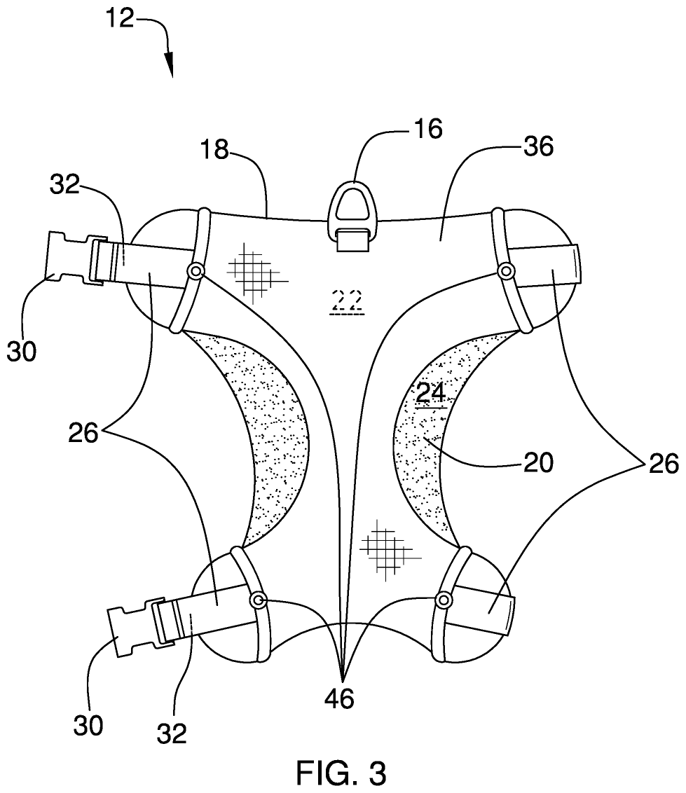

With reference now to the drawings, and in particular to FIGS. 1 through 5 thereof, a new harness pack assembly embodying the principles and concepts of an embodiment of the disclosure and generally designated by the reference numeral 10 will be described.

As best illustrated in FIGS. 1 through 5, the canine harness pack assembly 10 generally comprises a harness 12 and a pack 14. The harness 12 is configured to be attachable to a canine so that the harness 12 is positioned around a chest of the canine. A ring 16 is engaged to the harness 12 and is configured to engage a leash.

The harness 12 comprises an upper section 18 and a lower section 20. The upper section 18 has a lower face 22, which is padded. The lower section 20 has an upper face 24, which is padded. Each of a set of straps 26 is engaged to and extends from a respective corner 28 of the upper section 18. Two of the straps 26 are engaged to the lower section 20. Each of the other two straps 26 has a first connector 30 engaged thereto distal from the upper section 18. The first connector 30 is positioned to selectively engage an associated second connector 32, which is engaged to the lower section 20, to removably engage the upper section 18 to the lower section 20 so that the harness 12 is engaged to the canine. The first connector 30 and the associated second connector 32 may comprise a side release buckle 34, or other connecting means, such as, but not limited to, conventional buckles, clasps, buckle trims, and the like.

The pack 14 is selectively engageable to a top 36 of the harness 12 so that the pack 14 is substantially centered on a back of the canine. The pack 14 is configured to have an item positioned therein so that the canine is positioned to transport the item. The pack 14 has an aperture 38 positioned in a forward edge 40 thereof. The aperture 38 is configured for insertion of the item therethrough and into the pack 14. A satchel closure 42 is engaged to the pack 14 and is configured to selectively close the aperture 38 so that the item is retained therein. The satchel closure 42 may comprise a hook and loop fastener 44, or other fastening means, such as, but not limited to, zippers, buttons, and the like.

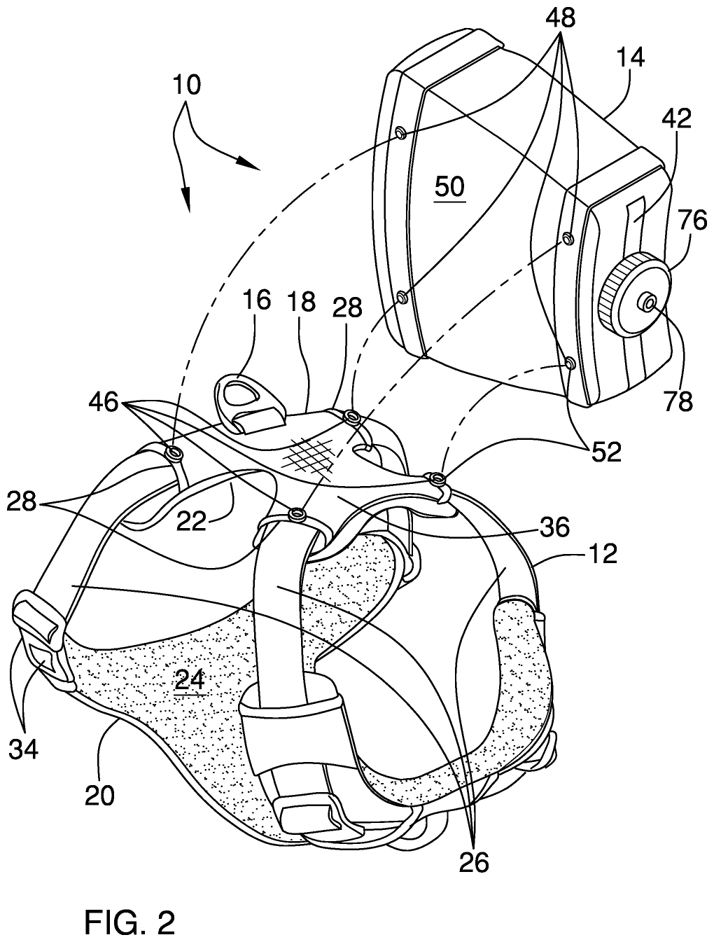

A set of first couplers 46 is engaged to the top 36 of the harness 12. A set of second couplers 48 is engaged to a lower surface 50 of the pack 14. The second couplers 48 are complementary to the first couplers 46 so that each second coupler 48 is positioned to selectively engage a respective first coupler 46 to removably engage the pack 14 to the harness 12. The second coupler 48 and the respective first coupler 46 may comprise a snap connector 52, as shown in FIG. 2, or other coupling means, such as, but not limited to, hook and loop connectors, snap hook and ring connectors, and the like.

A panel 54 engaged to an upper surface 88 of the pack 14 defines a pocket 56. The panel 54 has a slit 58 positioned in a front edge 60 thereof, which is configured to allow insertion of an article into the pocket 56. A pouch closure 62 is engaged to the panel 54 and is configured to selectively close the slit 58 so that the article is retained therein. The pouch closure 62 may comprise a zipper 64, or other closure means, such as, but not limited to, hook and loop closures, buttons, and the like.

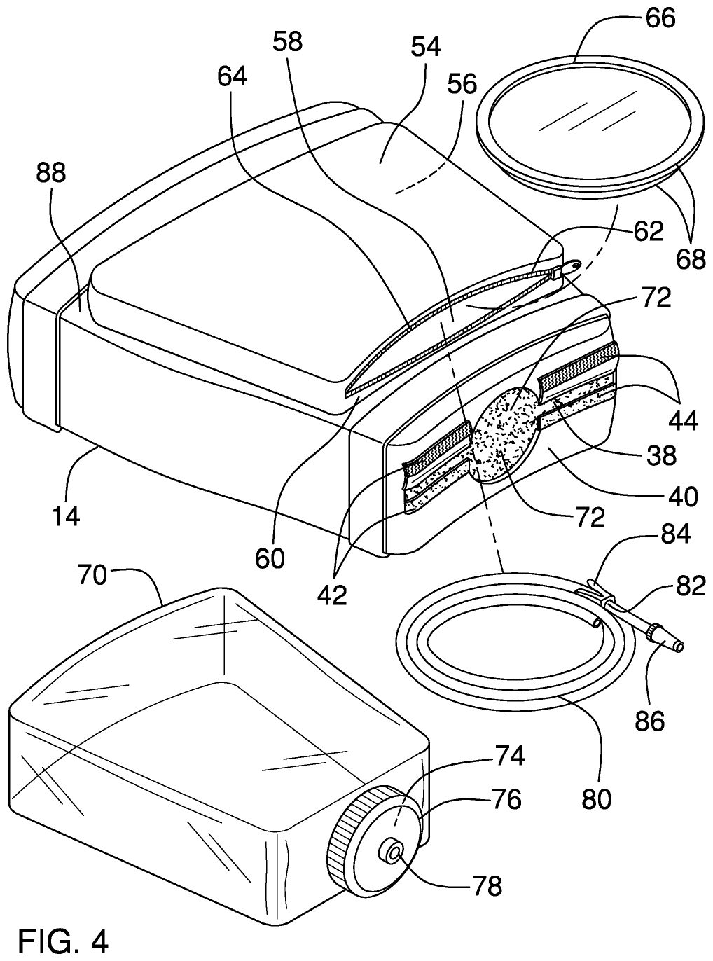

The assembly 10 also may comprise a bowl 66, as shown in FIG. 4. The bowl 66 comprises elastomer, silicone, or rubber so that the bowl 66 is resiliently flexible. The bowl 66 comprises a plurality of nested sections 68 so that the bowl 66 is selectively extensible. The bowl 66 in a collapsed configuration is selectively insertable through the slit 58 into the pocket 56.

The assembly 10 also may comprise a bladder 70, which is selectively insertable through the aperture 38 into the pack 14. The bladder 70 is configured to have water positioned therein and is externally insulated. The pack 14 also may be insulated so that the pack 14 is configured to slow heat adsorption of water positioned in the bladder 70.

The satchel closure 42 has a cutout 72 extending therethrough and into the forward edge 40 of the pack 14, as shown in FIG. 4. The cutout 72 is circular. A spout 74 is engaged to the bladder 70 so that the spout 74 is in fluidic communication therewith. The spout 74 extends through the cutout 72 when the bladder 70 is positioned in the pack 14. The spout 74 is configured to allow addition of water to the bladder 70.

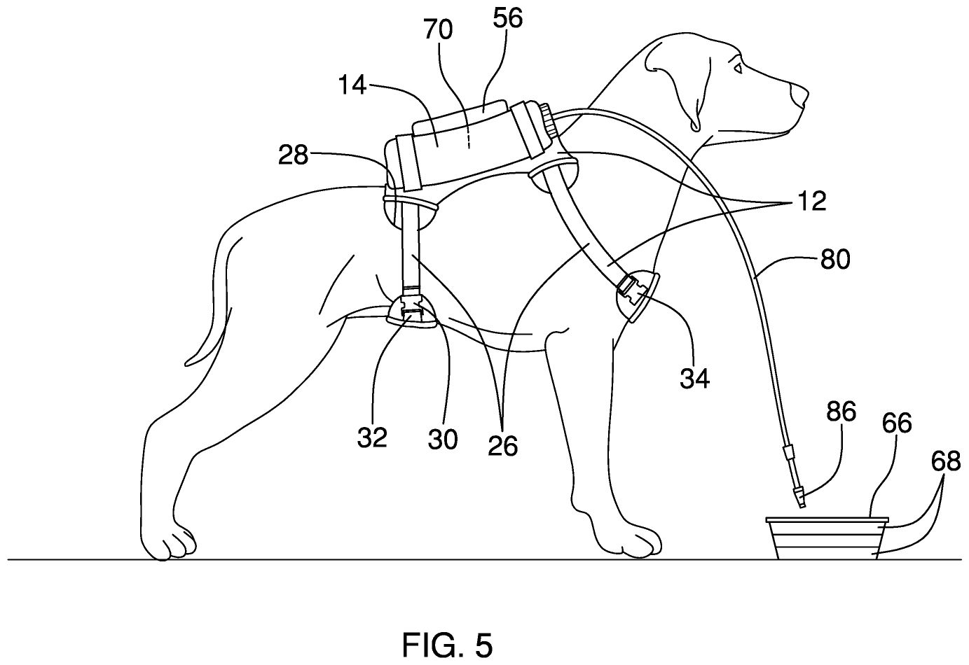

A cap 76 is selectively engageable to the spout 74. A pipe 78 is engaged to the cap 76 and extends therefrom. A tube 80 is selectively engageable to the pipe 78 so that the tube 80 is in fluidic communication with the bladder 70. The tube 80 is configured to direct a flow of water from the bladder 70, as shown in FIG. 5.

A valve 82 is positioned in the tube 80 distal from the pipe 78. A clip 84 is engaged to the tube 80 and is operationally engaged to the valve 82. The clip 84 is spring loaded and V-shaped and thus is configured to be selectively compressed between digits of a hand of a user to actuate the valve 82 to initiate the flow of water through the tube 80.

A nozzle 86 is engaged to the tube 80 distal from the pipe 78. The nozzle 86 is configured to control the flow of water through the tube 80. The nozzle 86 is selectively rotatable relative to the tube 80 to control the flow of water through the tube 80.

In use, the harness 12 is secured to the canine using the side release buckles 34. The bladder 70 is filled with water and then inserted into the pack 14. The bowl 66 is inserted into the pocket 56, and the pack 14 then can be attached to the harness 12 using the snap connectors 52. With a leash engaged to the ring 16, a user is positioned to walk the canine while the canine carries the water and the bowl 66. When the time comes for the canine to have a drink, the bowl 66 can be extracted from the pocket 56 and extended. Water from the bladder 70 can be transferred through the tube 80 into the bowl 66 so that the canine can get a drink from the bowl 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A canine harness pack assembly comprising:
a harness configured to be attachable to a canine, such that the harness is positioned around a chest of the canine; and
a pack selectively engageable to a top of the harness, such that the pack is substantially centered on a back of the canine, wherein the pack is configured for positioning of an item, such that the canine is positioned for transporting the item.

2. The canine harness pack assembly of claim 1, wherein the harness comprises:
an upper section;
a lower section; and
a set of straps, two straps of the set of straps each being engaged to and extending between a respective corner of the upper section and the lower section, the other two of the straps each being engaged to and extending from a respective corner of the upper section and having a first connector engaged thereto distal from the upper section, such that the first connector is positioned for selectively engaging an associated second connector engaged to the lower section for removably engaging the upper section to the lower section, such that the harness is engaged to the canine.

3. The canine harness pack assembly of claim 2, wherein:
the upper section has a lower face, the lower face being padded; and
the lower section has an upper face, the upper face being padded.

4. The canine harness pack assembly of claim 2, wherein the first connector and the associated second connector comprise a side release buckle.

5. The canine harness pack assembly of claim 1, further including a ring engaged to the harness and being configured for engaging a leash.

6. The canine harness pack assembly of claim 1, further including:
the pack having an aperture positioned in a forward edge thereof, wherein the aperture is configured for insertion of the item therethrough and into the pack; and
a satchel closure engaged to the pack and being configured for selectively closing the aperture, such that the item is retained therein.

7. The canine harness pack assembly of claim 6, wherein the satchel closure comprises a hook and loop fastener.

8. The canine harness pack assembly of claim 1, further including:
a set of first couplers engaged to the top of the harness; and
a set of second couplers engaged to a lower surface of the pack, the second couplers being complementary to the first couplers, such that each second coupler is positioned for selectively engaging a respective first coupler for removably engaging the pack to the harness.

9. The canine harness pack assembly of claim 8, wherein the second coupler and the respective first coupler comprise a snap connector.

10. The canine harness pack assembly of claim 1, further including:
a panel engaged to an upper surface of the pack defining a pocket, the panel having a slit positioned in a front edge thereof, wherein the slit is configured for allowing insertion of an article into the pocket; and
a pouch closure engaged to the panel and being configured for selectively closing the slit, such that the article is retained therein.

11. The canine harness pack assembly of claim 10, wherein the pouch closure comprises a zipper.

12. The canine harness pack assembly of claim 10, further including a bowl, the bowl comprising elastomer, silicone, or rubber, such that the bowl is resiliently flexible, the bowl comprising a plurality of nested sections, such that the bowl is selectively extensible, such that the bowl in a collapsed configuration is selectively insertable through the slit into the pocket.

13. The canine harness pack assembly of claim 6, further including a bladder selectively insertable through the aperture into the pack, wherein the bladder is configured for positioning water.

14. The canine harness pack assembly of claim 13, further including the pack being insulated, wherein the pack is configured for slowing heat adsorption of water positioned in the bladder.

15. The canine harness pack assembly of claim 13, further including:
the satchel closure having a cutout extending therethrough into the forward edge of the pack, the cutout being circular;
a spout engaged to the bladder such that the spout is in fluidic communication therewith, and such that the spout extends through the cutout when the bladder is positioned in the pack, wherein the spout is configured for addition of water to the bladder; and
a cap selectively engageable to the spout.

16. The canine harness pack assembly of claim 15, further including:
a pipe engaged to the cap and extending therefrom;
a tube selectively engageable to the pipe, such that the tube is in fluidic communication with the bladder, wherein the tube is configured for directing a flow of water from the bladder;
a valve positioned in the tube distal from the pipe; and
a clip engaged to the tube and being operationally engaged to the valve, the clip being spring loaded and V-shaped, wherein the clip is configured for being selectively compressed between digits of a hand of a user for actuating the valve for initiating the flow of water through the tube.

17. The canine harness pack assembly of claim 16, further including a nozzle engaged to the tube distal from the pipe, wherein the nozzle is configured for controlling the flow of water through the tube.

18. The canine harness pack assembly of claim 1, wherein the nozzle is selectively rotatable relative to the tube for controlling the flow of water through the tube.

19. The canine harness pack assembly of claim 13, further including the bladder being externally insulated.

20. A canine harness pack assembly comprising:
a harness configured to be attachable to a canine, such that the harness is positioned around a chest of the canine, the harness comprising:
an upper section, the upper section having a lower face, the lower face being padded,
a lower section, the lower section having an upper face, the upper face being padded, and
a set of straps, two straps of the set of straps each being engaged to and extending between a respective corner of the upper section and the lower section, the other two of the straps each being engaged to and extending from a respective corner of the upper section and having a first connector engaged thereto distal from the upper section, such that the first connector is positioned for selectively engaging an associated second connector engaged to the lower section for removably engaging the upper section to the lower section, such that the harness is engaged to the canine, the first connector and the associated second connector comprising a side release buckle;
a ring engaged to the harness and being configured for engaging a leash;
a pack selectively engageable to a top of the harness, such that the pack is substantially centered on a back of the canine, wherein the pack is configured for positioning of an item, such that the canine is positioned for transporting the item, the pack having an aperture positioned in a forward edge thereof, wherein the aperture is configured for insertion of the item therethrough and into the pack;
a satchel closure engaged to the pack and being configured for selectively closing the aperture, such that the item is retained therein, the satchel closure comprising a hook and loop fastener, the satchel closure having a cutout extending therethrough into the forward edge of the pack, the cutout being circular;
a set of first couplers engaged to the top of the harness;
a set of second couplers engaged to a lower surface of the pack, the second couplers being complementary to the first couplers, such that each second coupler is positioned for selectively engaging a respective first coupler for removably engaging the pack to the harness, the second coupler and the respective first coupler comprising a snap connector;
a panel engaged an upper surface of the pack defining a pocket, the panel having a slit positioned in a front edge thereof, wherein the slit is configured for allowing insertion of an article into the pocket;
a pouch closure engaged to the panel and being configured for selectively closing the slit, such that the article is retained therein, the pouch closure comprising a zipper;
a bowl, the bowl comprising elastomer, silicone, or rubber, such that the bowl is resiliently flexible, the bowl comprising a plurality of nested sections, such that the bowl is selectively extensible, such that the bowl in a collapsed configuration is selectively insertable through the slit into the pocket;
a bladder selectively insertable through the aperture into the pack, wherein the bladder is configured for positioning water, the bladder being externally insulated;
the pack being insulated, wherein the pack is configured for slowing heat adsorption of water positioned in the bladder;
a spout engaged to the bladder such that the spout is in fluidic communication therewith, and such that the spout extends through the cutout when the bladder is positioned in the pack, wherein the spout is configured for addition of water to the bladder;
a cap selectively engageable to the spout;
a pipe engaged to the cap and extending therefrom;
a tube selectively engageable to the pipe, such that the tube is in fluidic communication with the bladder, wherein the tube is configured for directing a flow of water from the bladder;
a valve positioned in the tube distal from the pipe;
a clip engaged to the tube and being operationally engaged to the valve, the clip being spring loaded and V-shaped, wherein the clip is configured for being selectively compressed between digits of a hand of a user for actuating the valve for initiating the flow of water through the tube; and
a nozzle engaged to the tube distal from the pipe, wherein the nozzle is configured for controlling the flow of water through the tube, the nozzle being selectively rotatable relative to the tube for controlling the flow of water through the tube.
